(19) United States
(12) Patent Application Publication
(10) Pub. No.: US 2008/0170213 A1
(43) Pub. Date: Jul. 17, 2008

(54) STAGE APPARATUS, EXPOSURE APPARATUS, AND DEVICE MANUFACTURING METHOD

(75) Inventor: Shinji Ohishi, Oyama-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 11/971,990

(22) Filed: Jan. 10, 2008

(30) Foreign Application Priority Data
Jan. 12, 2007 (JP) 2007-005083
Dec. 14, 2007 (JP) 2007-324017

(51) Int. Cl. G03B 27/32; H02K 41/02

(52) U.S. Cl. 355/53; 355/75; 310/12

(57) ABSTRACT

A stage apparatus includes a stage, a repulsive force generating unit including a first magnet provided on the stage and a second magnet provided to face the first magnet at an end of the moving stroke of the stage, a driving unit which drives the stage within the moving stroke of the stage, and a brake unit which includes an eddy current generating member arranged so as to suppress the movement of the first magnet.

### BACKGROUND OF THE INVENTION

1. Field of the Invention

The present invention relates to a stage apparatus, exposure apparatus, and device manufacturing method for manufacturing a device.

2. Description of the Related Art

An exposure apparatus uses a stage apparatus to accurately align a substrate (or original plate). Japanese Patent Laid-Open No. 2004-79639 discloses a technique which utilizes the repulsive force of a permanent magnet to obtain an accelerating force to obtain an acceleration for moving a stage.

The stage apparatus disclosed in Japanese Patent Laid-Open No. 2004-79639 will be explained with reference to FIGS. 12A and 12B. A stage 1204 mounts a substrate (or original plate) 1202 to be aligned. Linear motors 1207, each including a permanent magnet and a coil serving as a linear motor stator 1206, drive the stage 1204 in the Y direction. Permanent magnets 1233 are attached to the front and back sides of the stage 1204, separately from the linear motors 1207. The stage 1204 can obtain a large acceleration by generating a repulsive force between the permanent magnet 1233 and a permanent magnet unit 1235 attached to a stage base 1201. As the force acting on the stage 1204 becomes large to some extent, a decelerating unit for safely stopping the stage 1204 becomes necessary.

Japanese Patent Laid-Open No. 61-131841 discloses a stage decelerating unit utilizing an eddy current. More specifically, a conductive plate is provided on a stage so as to be sandwiched between a pair of magnetic poles provided on a stage base. An eddy current generated by the conductive plate produces a resistance force against the movement of the conductive plate, so this resistance force is utilized for vibration suppression.

However, when the conductive plate is provided on the stage base as the decelerating unit of the stage as described in Japanese Patent Laid-Open No. 61-131841, the conductive plate heats up due to the presence of the eddy current. For this reason, thermal deformation of the stage occurs and adversely affects the alignment accuracy of the stage. Still worse, the arrangement in which the conductive plate is additionally provided on the stage as described in Japanese Patent Laid-Open No. 61-131841 falls behind the recent technical trend toward simplification/weight reduction to improve the stage accuracy.

### SUMMARY OF THE INVENTION

The present invention has been made in consideration of the above-described problems, and has as its exemplary object to suppress the influence of heat generated upon driving a stage on the stage.

According to the first aspect of the present invention, there is provided a stage apparatus which comprises a stage, a repulsive force generating unit configured to apply a force to the stage by utilizing a magnetic repulsive force, the repulsive force generating unit including a first magnet provided on the stage, and a second magnet provided to face the first magnet at an end of a moving stroke of the stage, a driving unit configured to drive the stage within the moving stroke of the stage, and a brake unit which includes an eddy current generating member arranged so as to suppress movement of the first magnet.

According to the second aspect of the present invention, there is provided a stage apparatus which comprises a stage, a magnet repulsive force generating unit which includes a magnet assembly and an inserted magnet, the magnet assembly incorporating a plurality of magnets arranged such that different poles of the plurality of magnets face each other vertically along a set direction with a spacing, and the inserted magnet being inserted in the spacing such that poles of the inserted magnet face identical poles of the plurality of magnets in the magnet assembly at an end of a moving stroke of the stage, a driving unit configured to drive the stage within the moving stroke of the stage, and a brake unit which includes an eddy current generating member arranged so as to suppress movement of the first magnet.

According to the third aspect of the present invention, there is provided an exposure apparatus which comprises an optical system configured to project exposure light, which strikes an original plate on which a pattern is formed, onto a substrate, and the above described stage apparatus, which is configured to hold and align one of the substrate and the original plate.

According to the forth aspect of the present invention, there is provided a device manufacturing method comprising the steps of preparing a substrate on which a latent image pattern is formed using the above described exposure apparatus, and developing the latent image pattern.

Further features of the present invention will become apparent from the following description of exemplary embodiments (with reference to the attached drawings).

### BRIEF DESCRIPTION OF THE DRAWINGS

FIGS. 1A and 1B are a plan view and perspective view showing a stage apparatus according to the preferred first embodiment of the present invention;

FIGS. 2A to 2C are side views showing the stage apparatus according to the preferred first embodiment of the present invention;

FIGS. 3A and 3B are side views showing a stage apparatus according to the preferred second embodiment of the present invention;

FIGS. 4A and 4B are views showing details of nonmagnetic conductor driving units according to the preferred first and second embodiments of the present invention;

FIGS. 5A to 5D are views showing details of nonmagnetic conductor driving units according to the preferred third embodiment of the present invention;

FIGS. 6A and 6B are side views showing a stage apparatus according to the preferred fourth embodiment of the present invention;

FIGS. 7A to 7C are views showing details of change units according to the preferred fourth embodiment of the present invention;

FIGS. 8A to 8C are views showing details of resistance value change units according to the preferred fifth embodiment of the present invention;

FIGS. 9A to 9D are views showing details of cooling devices according to the preferred sixth embodiment of the present invention;

FIG. 10 is a conceptual view showing an exposure apparatus to which a stage apparatus according to a preferred embodiment of the present invention is applied;

FIG. 11 is a flowchart illustrating the sequence of the overall semiconductor device manufacturing process; and

FIGS. 12A and 12B are perspective views showing a stage apparatus having a conventional repulsion accelerating unit.

### DESCRIPTION OF THE EMBODIMENTS

### First Embodiment

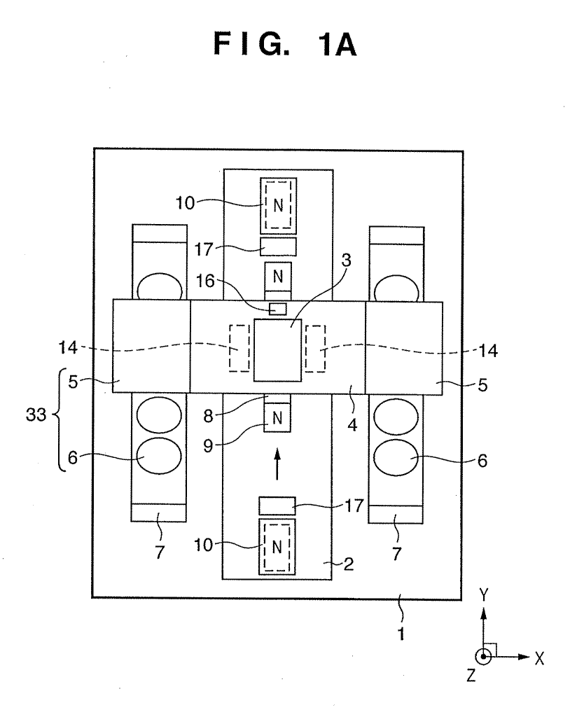

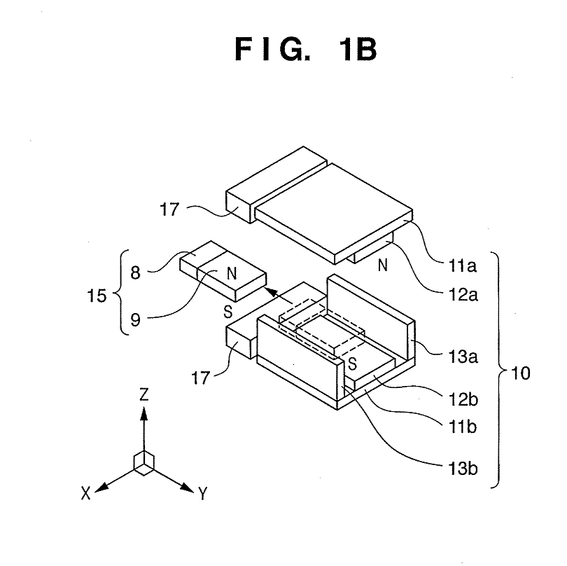

FIG. 1A is a plan view showing a stage apparatus according to the preferred first embodiment of the present invention. FIG. 1B is a perspective view showing a repulsion magnet unit (repulsive force generating unit).

In this stage apparatus, a base guide 2 is fixed on a main body base 1, and a stage 4 which mounts a processing object 3 is supported to be movable relative to the base guide 2 in one axial direction. Bearings 14 inserted between the upper surface of the base guide 2 and the lower surface of the stage 4 regulate the orientation of the stage 4. Since a semiconductor exposure apparatus is required to have high alignment accuracy, an air bearing is preferably used as the bearing 14. Linear motor movable elements 5 are fixed on the two sides of the stage 4. A linear motor stator 6 faces the linear motor movable element 5 in a noncontact manner, and is fixed on the main body base 1 via legs 7 at its two ends. The position of the stage 4 is measured by irradiating a reflecting mirror 16 with a laser beam from an interferometer.

This stage apparatus comprises repulsion magnet units shown in FIG. 1B. Magnet repulsion movable elements 15 each including a movable magnet holder 8 and movable magnet 9 are fixed on the front and back sides of the stage 4. The movable magnet 9 is a plate-like single-pole permanent magnet magnetized in the vertical direction. In this embodiment, the upper side of the movable magnet 9 is magnetized into an N pole. The magnet repulsion movable element 15 interacts with a magnet repulsion stator 10 arranged on the base guide 2 to apply a repulsive force to the stage 4, thereby accelerating/decelerating it.

A feature of the above-described structure of the repulsion magnet unit is that the direction in which it generates a repulsive force is perpendicular to the magnetization direction of the permanent magnet. Assume, for example, that identical poles of magnets magnetized in the Y direction are made to face each other. Even in this case, it is possible to obtain a repulsive force in the Y direction. However, the distance along which the repulsive force can have an influence is so short that the stage 4 cannot reach a sufficiently high speed.

As shown in FIG. 1B, magnets of the same polarity are made to face each other to utilize a force generated in a direction perpendicular to the direction in which they face each other. This makes it possible to obtain a force generation stroke corresponding to the sizes of the magnets of the same polarity which face each other. In addition, this repulsion magnet unit has a structure in which upper and lower magnets 12a and 12b sandwich the respective pole faces of the movable magnet 9 from both sides. This makes it possible to cancel a repulsive force in the direction in which they face each other.

The magnet repulsion stator 10 for applying an accelerating/decelerating force to the stage 4 is fixed on the base guide 2 in correspondence with the magnet repulsion movable element 15. The magnet repulsion stators 10 are set at the two ends of the stroke of the stage 4.

The magnet repulsion stator 10 includes, as a magnet assembly, an upper yoke 11a, the upper magnet 12a, two side yokes 13a and 13b, the lower magnet 12b, and a lower yoke 11b. The upper and lower magnets 12a and 12b are plate-like single-pole permanent magnets magnetized in the vertical direction, like the magnet repulsion movable element 15. The poles of the upper and lower magnets 12a and 12b face identical poles of the magnet repulsion movable element 15. That is, the lower surface of the upper magnet 12a corresponds to an N pole, while the upper surface of the lower magnet 12b corresponds to an S pole. The upper yoke 11a, side yokes 13a and 13b, and lower yoke 11b are provided so that the magnetic fluxes of the upper and lower magnets 12a and 12b run through them sideways.

The interval between the upper and lower magnets 12a and 12b needs only be wider than the thickness of the movable magnet 9. The inner interval between the two side yokes 13a and 13b needs only be wider than the width of the movable magnet 9. The movable magnet 9 is configured to be inserted in an opening in a noncontact manner, which is formed among the pair of upper and lower magnets 12a and 12b and two side yokes 13a and 13b.

FIG. 1B is a perspective view showing only the repulsion magnet unit serving as a repulsion system. When the magnet repulsion movable element 15 is present at a dotted position, it receives a repulsive force in the direction indicated by an arrow. As the magnet repulsion movable element 15 is pushed out from the dotted position upon receiving the repulsive force in the direction indicated by the arrow, the magnitude of the repulsive force decreases. When the magnet repulsion movable element 15 separates from the magnet repulsion stator 10 to a certain extent, the magnitude of the repulsive force becomes zero. Since the stage 4 has already been accelerated to a maximum speed and is guided by the bearings 14, it moves to the opposite side while keeping its speed at this time.

The linear motor movable element 5 produces a force so that the stage 4 keeps a constant speed against deceleration actions attributed to the air resistance and bearings. The kinetic energy of the stage 4 is conserved until the magnet repulsion movable element 15 on the opposite side of the stage 4 interacts with the magnet repulsion stator 10 at the other end. Hence, the speed of the magnet repulsion movable element 15 on the opposite side of the stage 4 also becomes zero while it is inserted into the magnet repulsion stator 10 at the other end by the same amount of insertion as that at the dotted position shown in FIG. 1B.

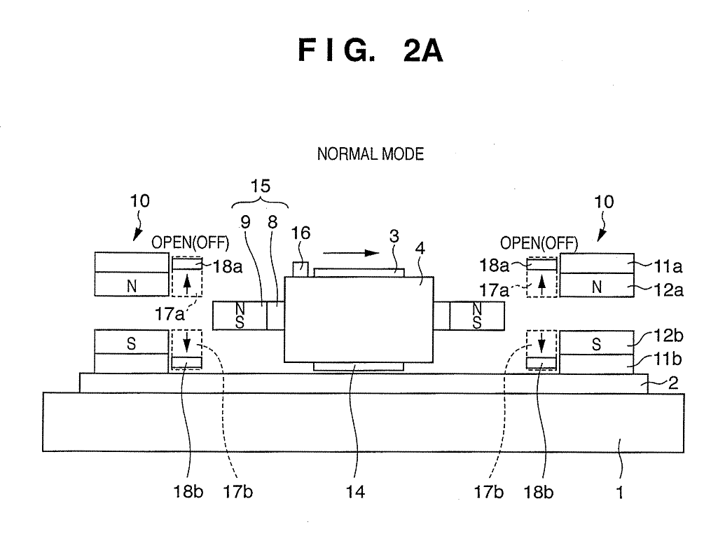

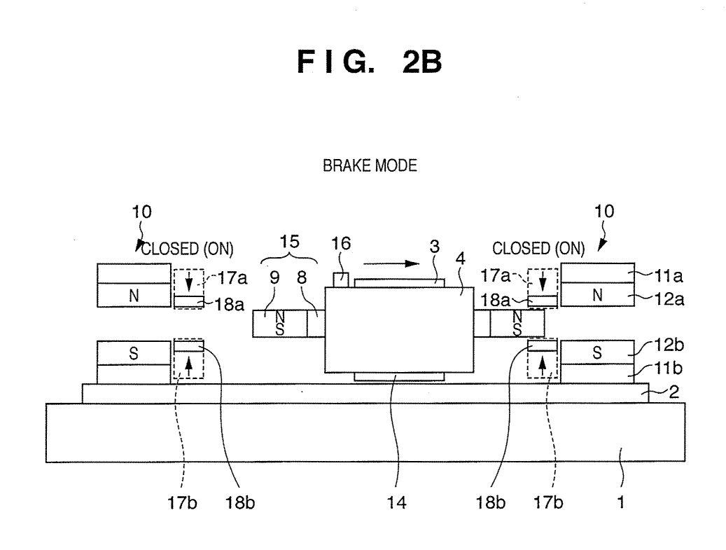

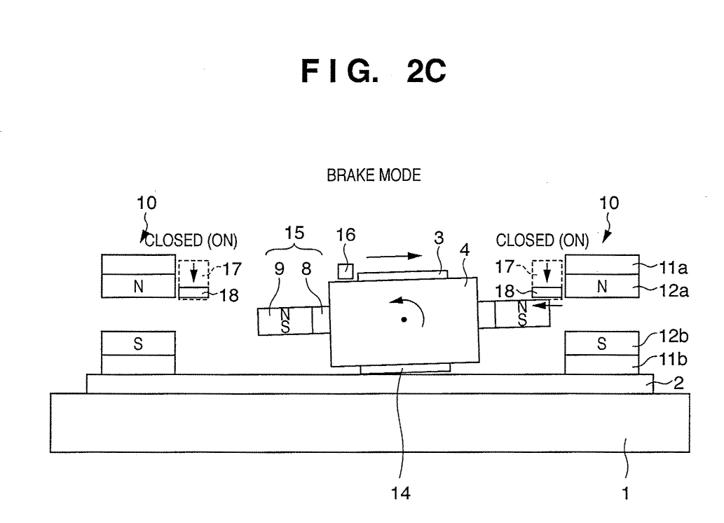

In the stage apparatus according to this embodiment, nonmagnetic conductor driving units 17a and 17b are interposed between the movable magnet 9 and the magnet repulsion stator 10 as eddy current brake units. FIGS. 2A to 2C are side views each showing a state in which the nonmagnetic conductor driving units 17a and 17b serving as the eddy current brake units operate the stage 4 accelerated by a magnet repulsive force. Nonmagnetic conductors 18a and 18b serving as eddy current generating members are brought close to the movable magnet 9 so as to face the movable magnet 9, thereby generating eddy currents.

FIG. 2A is a side view showing the stage apparatus having the nonmagnetic conductor driving units 17a and 17b in a normal mode according to the preferred first embodiment of the present invention. The nonmagnetic conductor driving units 17a and 17b hold the nonmagnetic conductors 18a and 18b at positions away from the movable magnet 9 (the brake is open (OFF)). In this state, no eddy currents are generated even when the movable magnet 9 passes between the nonmagnetic conductors 18a and 18b. Since no brake force acts on the stage 4, the repulsion magnet units provided at the two ends continue acceleration/deceleration driving.

FIG. 2B is a side view showing the stage apparatus having the nonmagnetic conductor driving units 17a and 17b in a brake mode executed in, for example, emergency stop. In the brake mode, the nonmagnetic conductor driving units 17a and 17b hold the nonmagnetic conductors 18a and 18b at positions close to the movable magnet 9 (the brake is closed (ON)). In this state, eddy currents are generated as the movable magnet 9 passes between the nonmagnetic conductors 18a and 18b so that a brake force acts on the stage 4.

The nonmagnetic conductor driving units 17a and 17b sandwich the nonmagnetic conductors 18a and 18b serving as the eddy current generating members from the upper and lower sides of the magnet repulsion movable element 15. As shown in FIG. 2C, when a nonmagnetic conductor driving unit 17 (nonmagnetic conductor 18) is arranged on one of the upper and lower sides of the magnet repulsion stator 10, no brake force generated by the nonmagnetic conductor driving unit 17 acts on the center of gravity of the stage 4. For this reason, a rotating force as indicated by an arrow acts on the stage 4 so that an overload is imposed on the bearing 14. In the worst case, the stage 4 comes into contact with the base guide 2, resulting in damage to the bearing 14. As shown in FIG. 2B, by sandwiching the nonmagnetic conductors 18a and 18b from the upper and lower sides of the movable magnet 9, a brake force acts on the center of gravity of the stage 4. This makes it possible to prevent damage to the bearing 14, thus safely stopping the stage 4.

In this embodiment, although the repulsion magnet unit has been explained by taking the arrangement in which the movable magnet 9 is inserted between the pair of permanent magnets 12a and 12b as an example, the present invention is not limited to this arrangement. The repulsion magnet units are preferably provided at the two ends of the stage. However, the repulsion magnet unit may be provided only at one end of the stage. That is, the repulsion magnet unit need only include a first magnet provided on the stage, and a second magnet provided to face the first magnet at an end of the moving stroke of the stage, to apply a force to the stage by utilizing a repulsive force acting between the first magnet and the second magnet.

### Second Embodiment

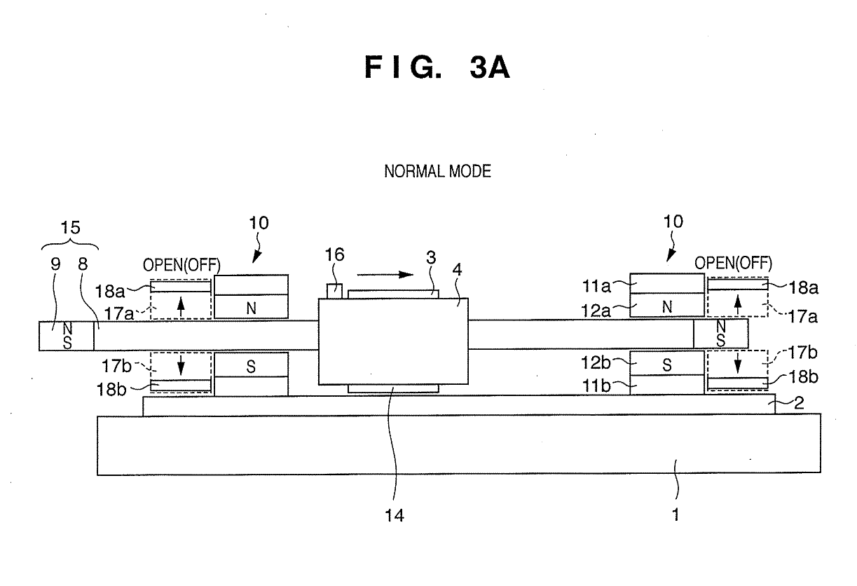

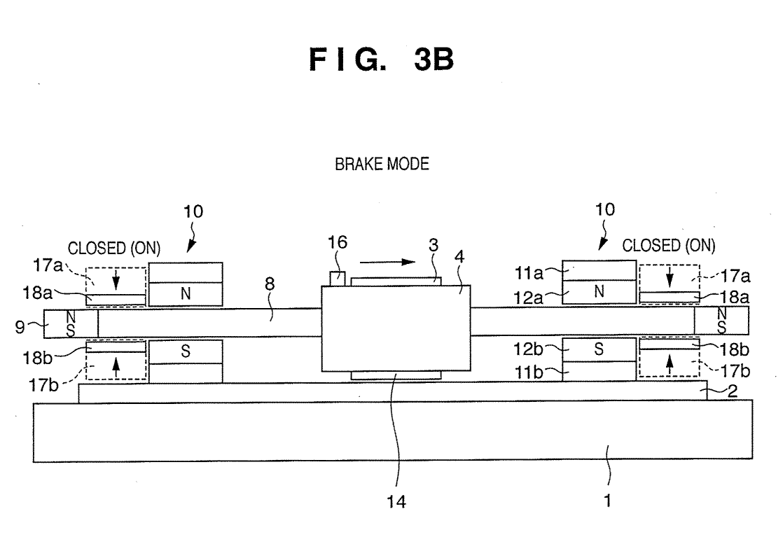

FIG. 3A is a side view showing a stage apparatus having nonmagnetic conductor driving units 17a and 17b in a normal mode according to the preferred second embodiment of the present invention. In the preferred second embodiment of the present invention, a movable magnet 9 is arranged outside a magnet repulsion stator 10. The nonmagnetic conductor driving units 17a and 17b hold nonmagnetic conductors 18a and 18b serving as eddy current generating members at positions away from the movable magnet 9 (the brake is open (OFF)). In this state, no eddy currents are generated even when the movable magnet 9 passes between the nonmagnetic conductors 18a and 18b. Since no brake force acts on a stage 4, repulsion magnet units provided at the two ends continue acceleration/deceleration driving.

FIG. 3B is a side view showing the stage apparatus having the nonmagnetic conductor driving units 17a and 17b in a brake mode executed in, for example, emergency stop. In the brake mode, the nonmagnetic conductor driving units 17a and 17b hold the nonmagnetic conductors 18a and 18b at positions close to the movable magnet 9 (the brake is closed (ON)). In this state, eddy currents are generated as the movable magnet 9 passes between the nonmagnetic conductors 18a and 18b so that a brake force acts on the stage 4.

By arranging a magnet repulsion movable element 15 outside the magnet repulsion stator 10, the nonmagnetic conductor driving units 17a and 17b can also be arranged outside the magnet repulsion stator 10. As the nonmagnetic conductor driving units 17a and 17b are arranged outside the magnet repulsion stator 10, it is easy to ensure their installation spaces and to perform their maintenance as compared with a case in which they are arranged inside the magnet repulsion stator 10. It is also possible to keep the stage 4 away from heat sources produced as the eddy currents flow through the nonmagnetic conductors 18a and 18b, thus suppressing thermal deformation of the stage 4 and improving the stop accuracy.

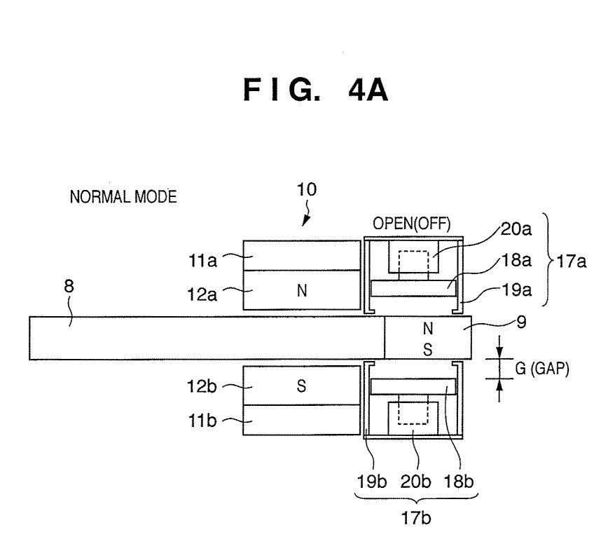

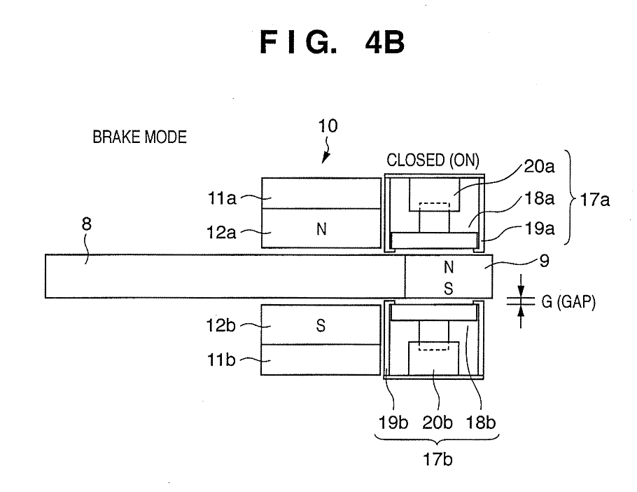

FIG. 4A is a view showing details of the nonmagnetic conductor driving units 17a and 17b in a normal mode according to the preferred first and second embodiments of the present invention. Actuators 20a and 20b vertically drive the nonmagnetic conductors 18a and 18b. Guide members 19a and 19b made of nonmagnetic nonconductors guide the nonmagnetic conductors 18a and 18b to move vertically. A direct-acting mechanism such as a solenoid or air cylinder is adopted as each of the actuators 20a and 20b.

In the normal mode, the nonmagnetic conductor driving units 17a and 17b hold the nonmagnetic conductors 18a and 18b at positions away from the movable magnet 9 (the brake is open (OFF)). In this state, a gap G between the movable magnet 9 and each of the nonmagnetic conductors 18a and 18b is wide. Since no eddy currents are generated by the nonmagnetic conductors 18a and 18b, no brake force acts on the movable magnet 9.

FIG. 4B is a view showing the nonmagnetic conductor driving units 17a and 17b in a brake mode executed in, for example, emergency stop. In the brake mode, the nonmagnetic conductor driving units 17a and 17b hold the nonmagnetic conductors 18a and 18b at positions close to the movable magnet 9 (the brake is closed (ON)). In this state, the gap G between the movable magnet 9 and each of the nonmagnetic conductors 18a and 18b is narrow. Since eddy currents are generated by the nonmagnetic conductors 18a and 18b, a brake force acts on the movable magnet 9.

### Third Embodiment

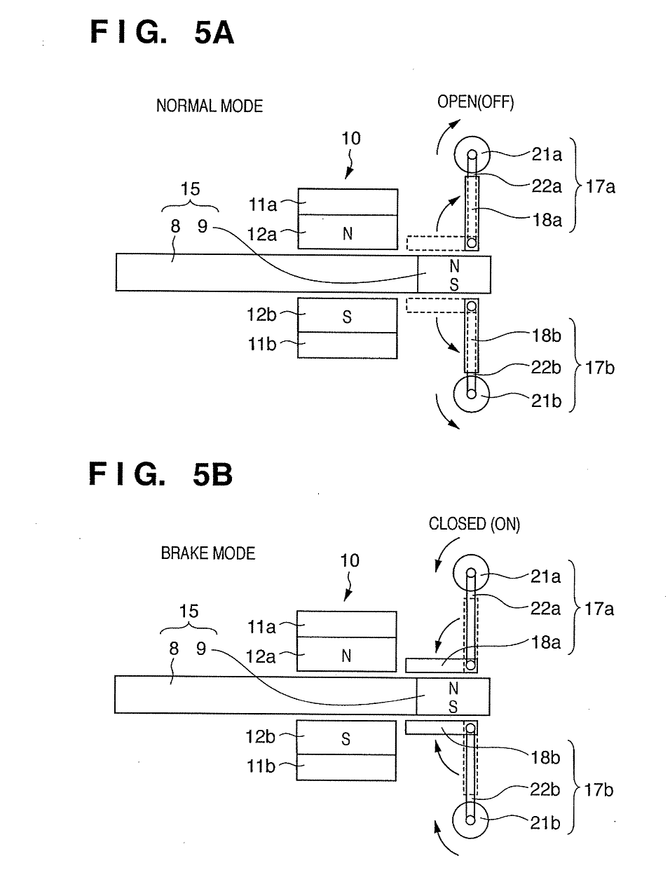

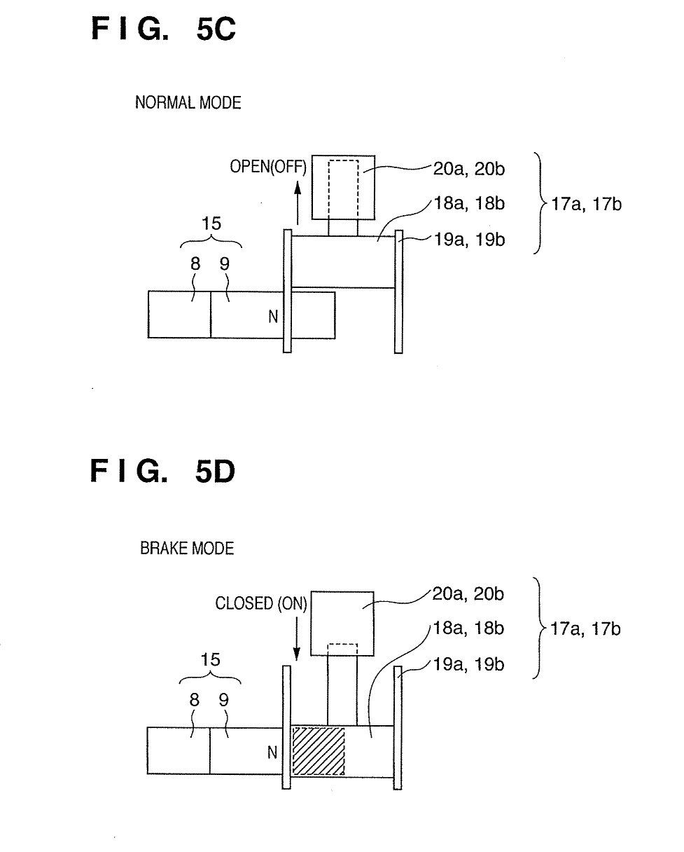

FIG. 5A is a view showing nonmagnetic conductor driving units 17a and 17b in a normal mode according to the preferred third embodiment of the present invention. In the preferred third embodiment of the present invention, nonmagnetic conductors 18a and 18b are rotatably supported so that rotating motors 21a and 21b, belts 22a and 22b, and the like can rotationally drive them. In the normal mode, the nonmagnetic conductors 18a and 18b are kept standing vertically by rotating the motors (the brake is open (OFF)). The areas of surfaces of the nonmagnetic conductors 18a and 18b which face a movable magnet 9 are equal to their thicknesses. If thin plates are used as the nonmagnetic conductors 18a and 18b, the areas of their surfaces which face the movable magnet 9 become very small. Since the magnitudes of generated eddy currents also become very small, a brake force hardly acts on the movable magnet 9.

FIG. 5B is a view showing the nonmagnetic conductor driving units 17a and 17b in a brake mode executed in, for example, emergency stop. The nonmagnetic conductors 18a and 18b are kept lying horizontally by rotating the motors (the brake is closed (ON)). The areas of surfaces of the nonmagnetic conductors 18a and 18b which face the movable magnet 9 can be as large as their wide surfaces. Since the magnitudes of generated eddy currents also become larger, a large brake force acts on the movable magnet 9.

The nonmagnetic conductor driving units 17a and 17b which slide the nonmagnetic conductors 18a and 18b from the two sides, as shown in the plan view of FIG. 5C, may be used to change the areas of the surfaces of the nonmagnetic conductors 18a and 18b, which face the movable magnet 9. Actuators 20a and 20b horizontally drive the nonmagnetic conductors 18a and 18b. Guide members 19a and 19b made of nonmagnetic nonconductors guide the nonmagnetic conductors 18a and 18b to move horizontally. A direct-acting mechanism such as a solenoid or air cylinder is adopted as each of the actuators 20a and 20b.

In a normal mode, the nonmagnetic conductor driving units 17a and 17b drive the nonmagnetic conductors 18a and 18b to positions at which they do not overlap the movable magnet 9 (the brake is open (OFF)). In this state, the nonmagnetic conductors 18a and 18b do not overlap the movable magnet 9 at all. Since no eddy currents are generated by the nonmagnetic conductors 18a and 18b, no brake force acts on the movable magnet 9.

FIG. 5D is a view showing the nonmagnetic conductor driving units 17a and 17b in a brake mode executed in, for example, emergency stop. In the brake mode, the nonmagnetic conductor driving units 17a and 17b drive the nonmagnetic conductors 18a and 18b to positions at which they overlap the movable magnet 9 (the brake is closed (ON)). In this state, the nonmagnetic conductors 18a and 18b overlap the movable magnet 9 in a region having an area indicated by a hatched portion. Since eddy currents are generated by the nonmagnetic conductors 18a and 18b, a brake force acts on the movable magnet 9.

As in the first embodiment, the nonmagnetic conductor driving units 17a and 17b sandwich the nonmagnetic conductors 18a and 18b from the upper and lower sides of a magnet repulsion movable element 15. As described above, the nonmagnetic conductors 18a and 18b are driven to change the areas of the surfaces of the nonmagnetic conductors 18a and 18b, which face the movable magnet 9. This makes it possible to adjust the eddy currents.

### Fourth Embodiment

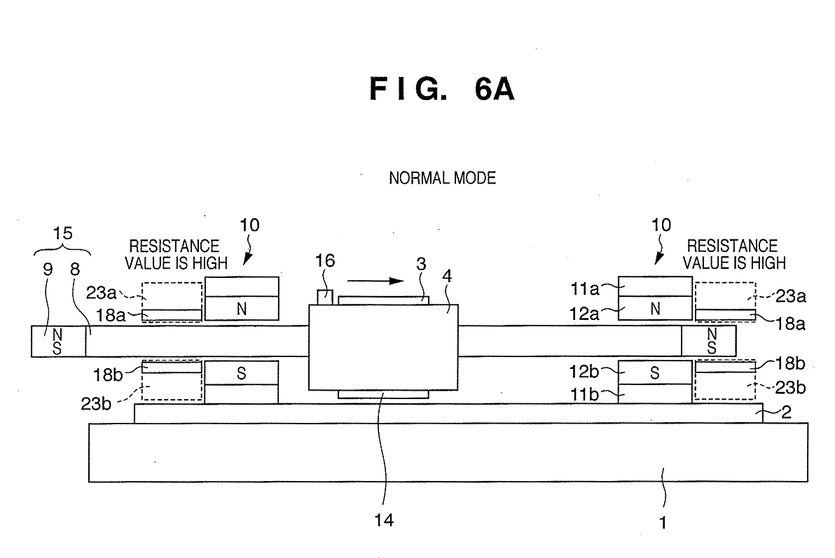

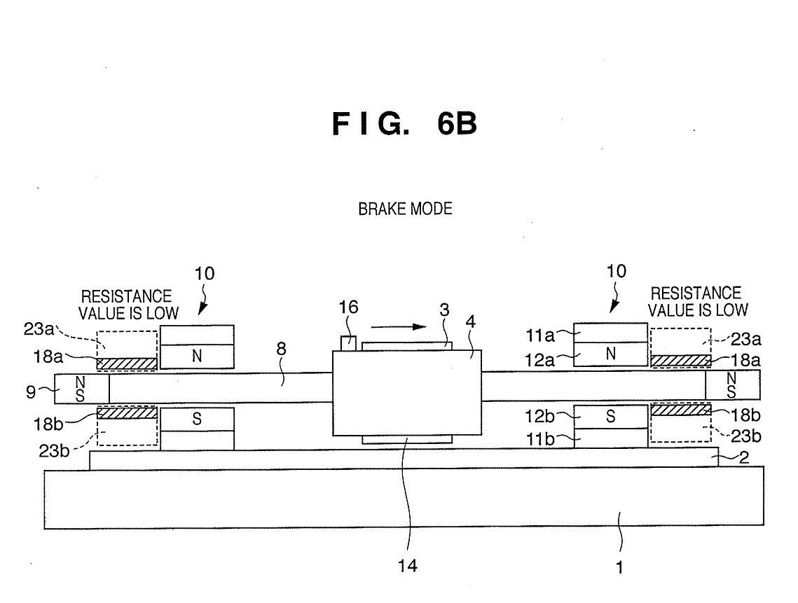

FIG. 6A is a side view showing a stage apparatus having resistance value change units 23a and 23b in a normal mode according to the preferred fourth embodiment of the present invention. In the preferred fourth embodiment of the present invention, nonmagnetic conductors 18a and 18b face a movable magnet 9 so that the resistance value change units 23a and 23b can adjust the resistance values of the nonmagnetic conductors 18a and 18b. As the resistance value change units 23a and 23b increase the resistance values of the nonmagnetic conductors 18a and 18b which face the movable magnet 9, no eddy currents are generated (the brake is open (OFF)). In this state, no eddy currents are generated by the nonmagnetic conductors 18a and 18b. Since no brake force acts on a stage 4, repulsion magnet units provided at the two ends continue acceleration/deceleration driving.

FIG. 6B is a side view showing the stage apparatus having the resistance value change units 23a and 23b in a brake mode executed in, for example, emergency stop. In the brake mode, as the resistance value change units 23a and 23b decrease the resistance values of the nonmagnetic conductors 18a and 18b which face the movable magnet 9, eddy currents are generated (the brake is closed (ON)). In this state, eddy currents are generated by the nonmagnetic conductors 18a and 18b so that a brake force acts on the stage 4.

As in the first embodiment, the resistance value change units 23a and 23b sandwich the nonmagnetic conductors 18a and 18b from the upper and lower sides of the magnet repulsion movable element 15. As described above, the nonmagnetic conductors 18a and 18b are driven to change the areas of the surfaces of the nonmagnetic conductors 18a and 18b, which face the movable magnet 9. This makes it possible to adjust the eddy currents.

### Fifth Embodiment

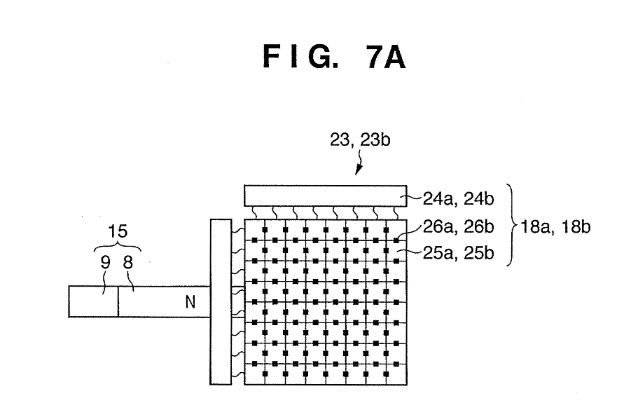

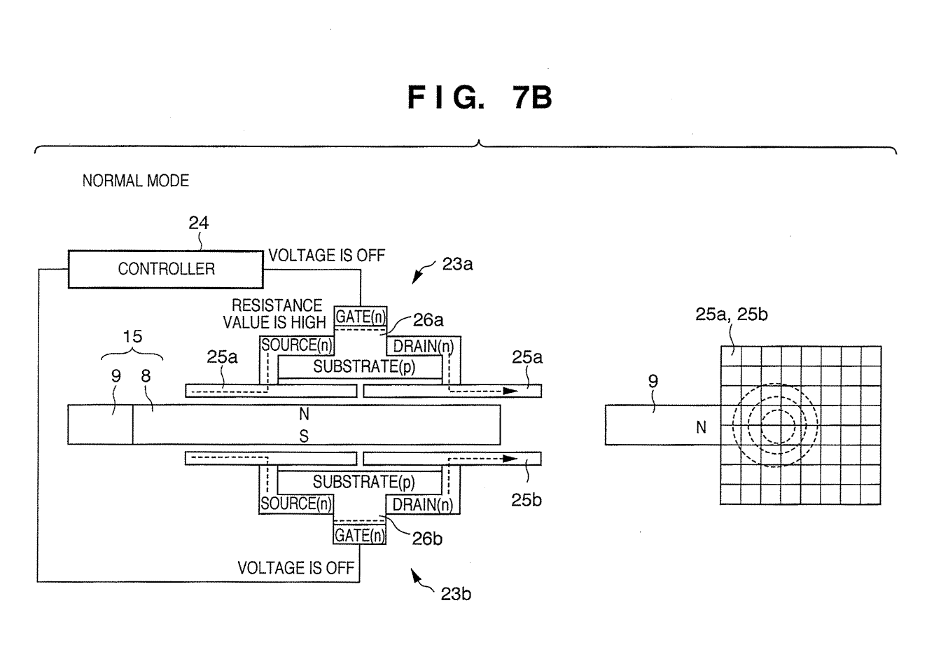

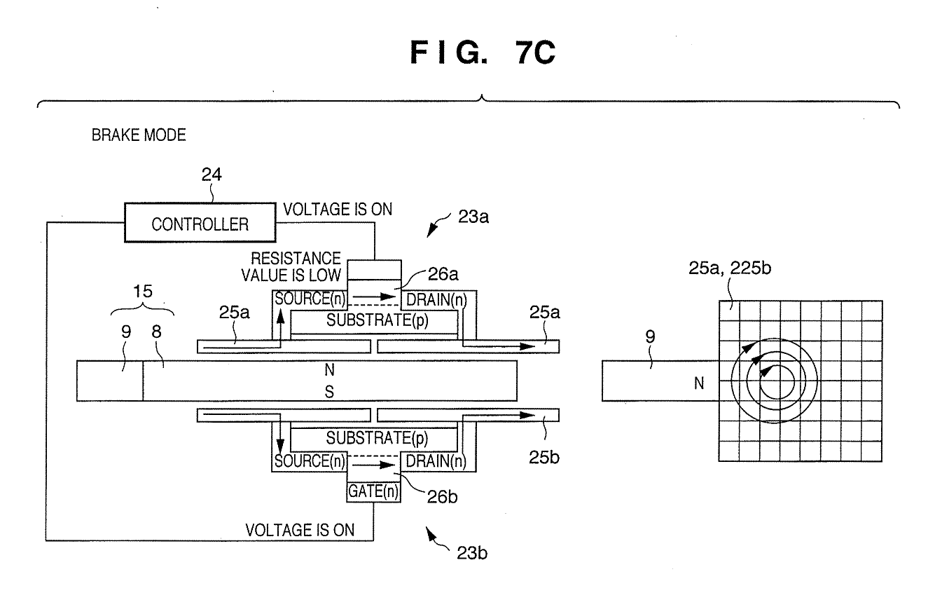

FIG. 7A is a view showing the arrangements of resistance value change units 23a and 23b according to the preferred fifth embodiment of the present invention. In the preferred fifth embodiment of the present invention, a plurality of nonmagnetic conductive substrates 25a and 25b each having an area sufficiently smaller than that of a movable magnet 9 are arrayed in a matrix. The individual nonmagnetic conductive substrates 25a and 25b are insulated so that adjacent ones do not electrically connect to each other. Switching elements 26a and 26b connect the nonmagnetic conductive substrates 25a and 25b in a matrix. When one wants to stop a stage 4 in case of emergency or to change its speed, the switching elements 26a and 26b are controlled upon receiving a signal from a controller 24.

FIG. 7B is a view showing the operations of the resistance value change units 23a and 23b in a normal mode according to the preferred fifth embodiment of the present invention. In the preferred fifth embodiment of the present invention, FETs (Field Effect Transistors) serving as semiconductor switching elements are provided as the switching elements 26a and 26b. When a voltage is applied to the gate of the FET, holes in a p-type semiconductor (indicated by “p” in FIG. 7) are depleted downward. As a result, an inversion layer in which electrons are populated is formed on the surface of the substrate (p). The electrons migrate between the source and the drain which serve as n-type impurity regions (indicated by “n” in FIG. 7), to supply a current between them. To supply eddy currents in two directions, two FETs need only be juxtaposed in opposite directions. The use of, for example, a semiconductor process allows to finely arrange FETs on nonmagnetic conductive substrates 25a and 25b.

As shown in FIG. 7B, in the normal mode, the resistance value between the source and the drain of each FET increases upon turning off a voltage applied from the controller 24. Since no eddy currents flow even when the movable magnet 9 passes between the nonmagnetic conductive substrates 25a and 25b, no brake force acts on the movable magnet 9.

As shown in FIG. 7C, in the brake mode, a current flows between the source and the drain of each FET upon turning on a voltage applied from the controller 24. Since eddy currents flow as the movable magnet 9 passes between the nonmagnetic conductive substrates 25a and 25b, a brake force acts on the movable magnet 9.

### Sixth Embodiment

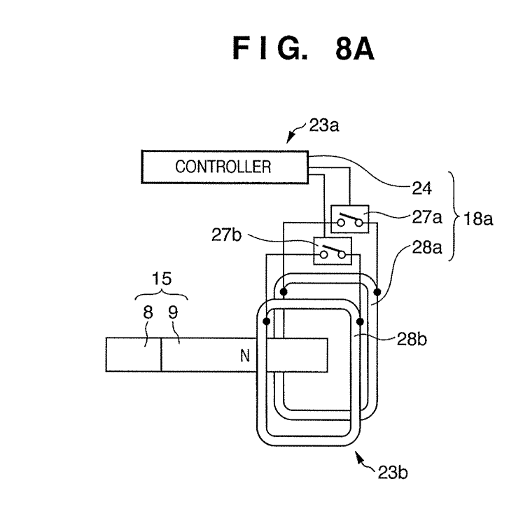

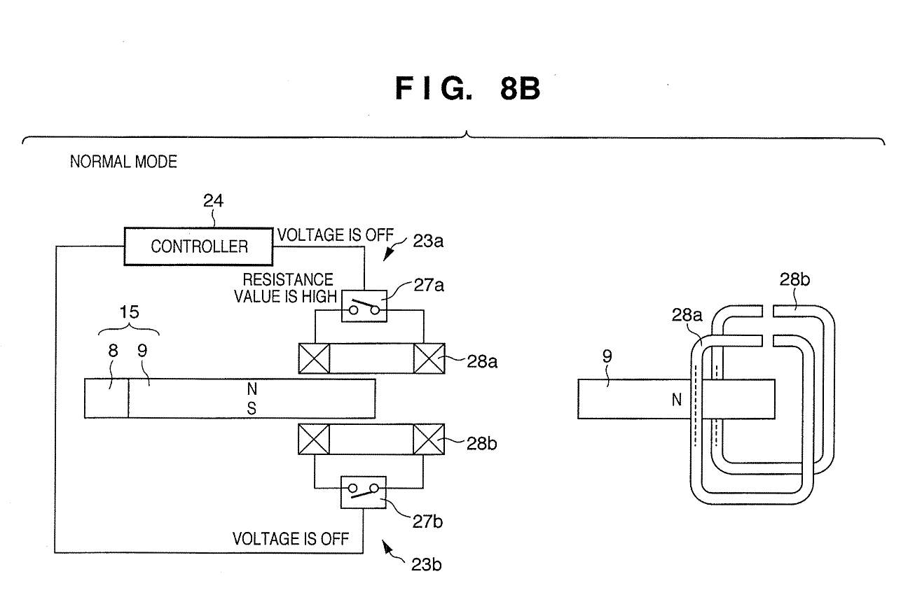

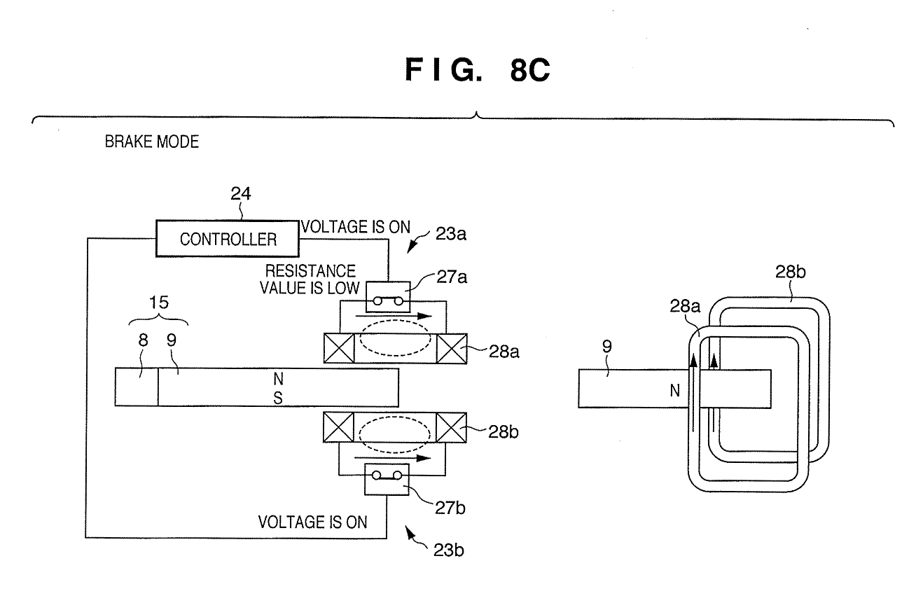

FIG. 8A is a view showing the arrangements of resistance value change units 23a and 23b according to the preferred sixth embodiment of the present invention. In the preferred sixth embodiment of the present invention, each of switches 27a and 27b connects to the two ends of a corresponding one of a plurality of coils 28a and 28b serving as eddy current generating members such that they face a movable magnet 9. When one wants to stop a stage 4 in case of emergency or to change its speed, a controller 24 controls the switches 27a and 27b. As the number of coils 28a and 28b increases, it is possible to increase the magnitude of a brake force. The controller 24 can adjust the brake force by selecting the coils 28a and 28b to be short-circuited.

FIG. 8B is a view showing the operations of the resistance value change units 23a and 23b in a normal mode according to the preferred sixth embodiment of the present invention. The two ends of each of the coils 28a and 28b are opened upon turning off the switches 27a and 27b in accordance with a signal from the controller 24. Since no eddy currents flow even when the movable magnet 9 passes between the coils 28a and 28b, no brake force acts on the movable magnet 9.

FIG. 8C is a view showing the operations of the resistance value change units 23a and 23b in a brake mode according to the preferred sixth embodiment of the present invention. The two ends of the coils 28a and 28b are short-circuited upon turning on the switches 27a and 27b in accordance with a signal from the controller 24. Since eddy currents flow as the movable magnet 9 passes between the coils 28a and 28b, a brake force acts on the movable magnet 9.

### Seventh Embodiment

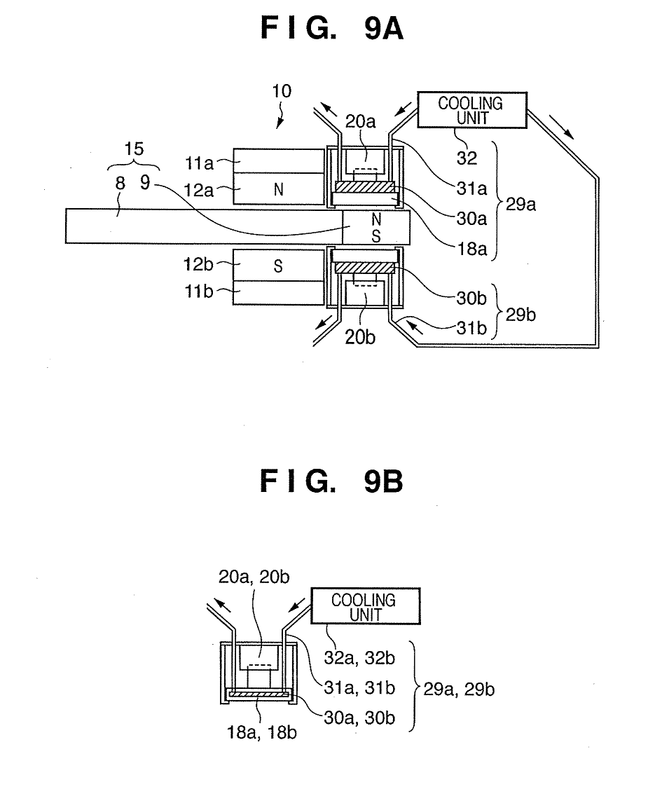

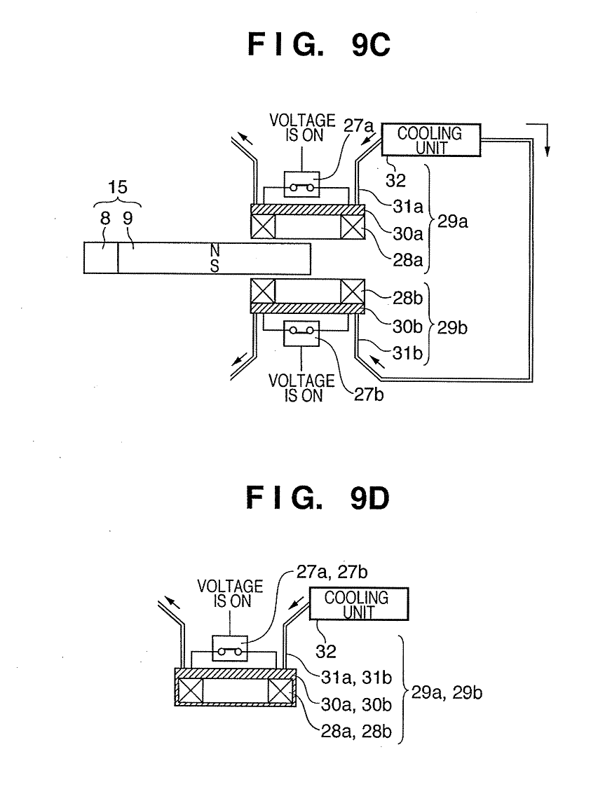

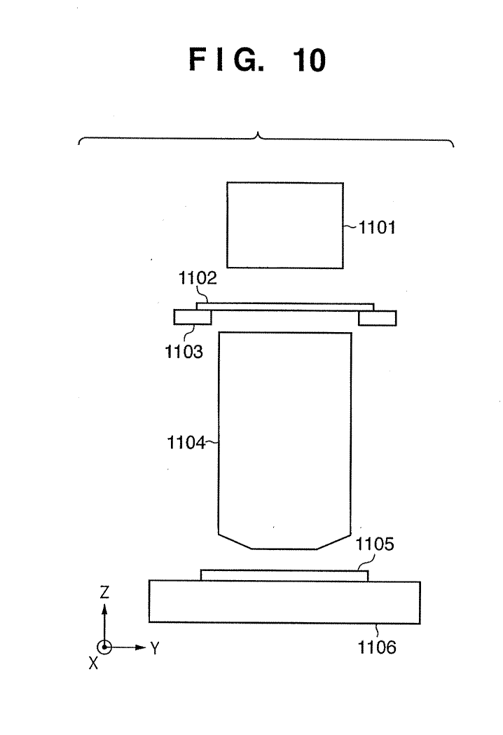

FIG. 9A is a view showing the arrangement of a nonmagnetic conductor driving unit having cooling devices 29a and 29b according to the preferred seventh embodiment of the present invention. Since eddy currents are generated as a movable magnet 9 passes under nonmagnetic conductors 18a and 18b, a brake force acts on the movable magnet 9. The eddy currents produce Joule heats upon flowing through the conductors.

To cope with this situation, cooling members 30a and 30b are brought into tight contact with the lower surfaces of the nonmagnetic conductors 18a and 18b so that a cooling unit 32 supplies a refrigerant to them through cooling pipes 31a and 31b. The cooling unit 32 supplies a cooling gas or cooling liquid as the refrigerant to discharge the Joule heats produced by the nonmagnetic conductors 18a and 18b to the outside. As shown in FIG. 9B, it is also possible to form a flow path in the nonmagnetic conductors 18a and 18b to integrate the cooling members 30a and 30b.

FIG. 9C is a view showing the arrangement of a resistance value change unit having the cooling devices 29a and 29b, like FIGS. 9A and 9B. Since eddy currents are generated as the movable magnet 9 passes between coils 28a and 28b, a brake force acts on the movable magnet 9. The eddy currents produce Joule heats upon flowing through the coils.

To cope with this situation, the cooling members 30a and 30b are brought into tight contact with the lower surfaces of the coils 28a and 28b so that the cooling unit 32 supplies a refrigerant to them through the cooling pipes 31a and 31b. The cooling unit 32 supplies a cooling gas or cooling liquid as the refrigerant to discharge the Joule heats produced by the coils 28a and 28b to the outside. As shown in FIG. 9D, it is also possible to cover the entire coils 28a and 28b with a jacket made of a nonmagnetic nonconductor such as a ceramic, thus enhancing the cooling efficiency.

As described above, when the cooling devices are provided to the nonmagnetic conductor driving unit, it is possible to discharge the Joule heats produced by eddy currents to the outside of the stage. This makes it possible to provide a stage apparatus with high stop accuracy, which is free from any influence of heat.

### APPLICATION EXAMPLE

FIG. 10 is a schematic view showing the arrangement of an exposure apparatus which is used for a semiconductor device manufacturing process and to which a stage apparatus 1105 according to the present invention is applied. Referring to FIG. 10, light emitted by an illumination optical system 1101 is applied on a reticle 1102 as an original plate. The reticle 1102 is held on a reticle stage 1103. The pattern of the reticle 1102 is reduced and projected at a magnification matching that of a reduction projection lens 1104. The image plane of the reduction projection lens 1104, on which a reticle pattern image is formed, is perpendicular to the Z direction. The surface of a processing object (substrate) 3 as an exposure target sample is coated with a resist and has an array of shot regions formed in an exposure process.

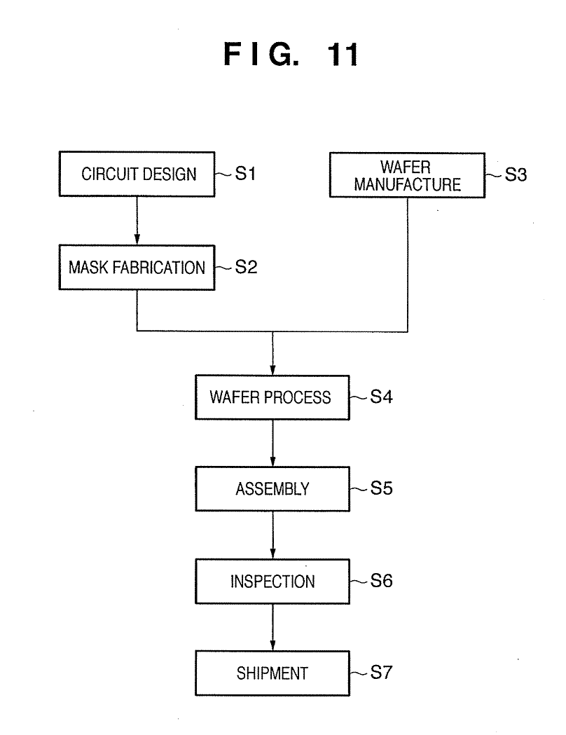

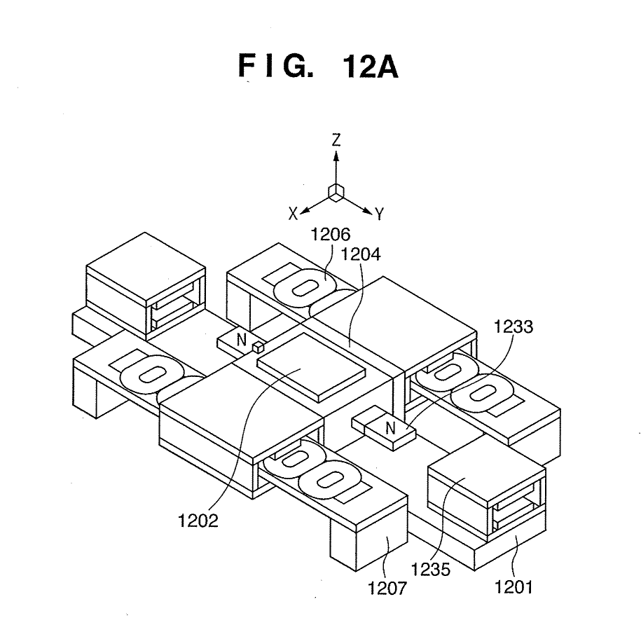

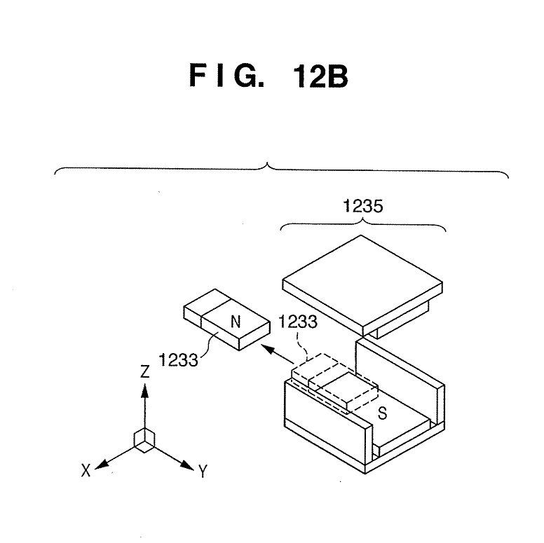

A semiconductor device manufacturing process using an exposure apparatus according to a preferred embodiment of the present invention will be explained next. FIG. 11 is a flowchart illustrating the sequence of the overall semiconductor device manufacturing process. In step S1 (circuit design), the circuit of a semiconductor device is designed. In step S2 (mask fabrication), a mask (also called an original plate or reticle) is fabricated based on the designed circuit pattern. In step S3 (wafer manufacture), a wafer (also called a substrate) is manufactured using a material such as silicon. In step S4 (wafer process) called a preprocess, the above-described exposure apparatus forms an actual circuit on the wafer by lithography using the mask and wafer. In step S5 (assembly) called a post-process, a semiconductor chip is formed using the wafer manufactured in step S4. This step includes processes such as assembly (dicing and bonding) and packaging (chip encapsulation). In step S6 (inspection), inspections including operation check test and durability test of the semiconductor device manufactured in step S5 are performed. A semiconductor device is completed with these processes and shipped in step S7.

The above-described wafer process in step S4 includes the following steps: an oxidation step of oxidizing the wafer surface; a CVD step of forming an insulating film on the wafer surface; an electrode formation step of forming an electrode on the wafer by vapor deposition; an ion implantation step of implanting ions in the wafer; a resist processing step of applying a photosensitive agent to the wafer; an exposure step of exposing the wafer having undergone the resist processing step, using the above-described exposure apparatus via the mask pattern to form a latent image pattern on the resist; a development step of developing the wafer exposed in the exposure step; an etching step of etching portions other than the latent image pattern developed in the development step; and a resist removal step of removing any unnecessary resist remaining after etching. By repeating these steps, a multilayered structure of circuit patterns is formed on the wafer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-005083, filed Jan. 12, 2007, and Japanese Patent Application No. 2007-324017, filed Dec. 14, 2007, which are hereby incorporated by reference herein in their entirety.

What is claimed is:

1. A stage apparatus comprising:
a stage;
a repulsive force generating unit configured to apply a force to the stage by utilizing a magnetic repulsive force, the repulsive force generating unit including a first magnet provided on the stage, and a second magnet provided to face the first magnet at an end of a moving stroke of the stage;
a driving unit configured to drive the stage within the moving stroke of the stage; and
a brake unit which includes an eddy current generating member arranged so as to suppress movement of the first magnet.

2. The apparatus according to claim 1, wherein the brake unit is configured such that a brake can be switched on and off.

3. The apparatus according to claim 1, wherein the eddy current generating member includes a plurality of eddy current generating members, and
the eddy current generating members are arranged with a spacing so as to sandwich the first magnet.

4. The apparatus according to claim 1, wherein the brake unit includes a cooling unit configured to cool the eddy current generating member.

5. The apparatus according to claim 1, wherein the brake unit includes an eddy current adjusting unit configured to adjust a magnitude of an eddy current generated by the eddy current generating member.

6. The apparatus according to claim 5, wherein the eddy current adjusting unit includes a gap adjusting unit configured to adjust a gap between the first magnet and the eddy current generating member.

7. The apparatus according to claim 5, wherein the eddy current adjusting unit includes an area adjusting unit configured to adjust an area of a surface of the eddy current generating member, which faces the first magnet.

8. The apparatus according to claim 5, wherein the eddy current adjusting unit includes a resistance value change unit configured to change a resistance value of the eddy current generating member.

9. The apparatus according to claim 8, wherein the resistance value change unit includes a plurality of nonmagnetic conductors arrayed in a matrix, and switching elements which respectively connect to the plurality of nonmagnetic conductors.

10. The apparatus according to claim 8, wherein the resistance value change unit includes a plurality of coils, and switching elements arranged at two ends of each of the plurality of coils.

11. A stage apparatus comprising:
a stage;
a magnet repulsive force generating unit which includes a magnet assembly and an inserted magnet, the magnet assembly incorporating a plurality of magnets arranged such that different poles of the plurality of magnets face each other vertically along a set direction with a spacing, and the inserted magnet being inserted in the spacing such that poles of the inserted magnet face identical poles of the plurality of magnets in the magnet assembly at an end of a moving stroke of the stage;
a driving unit configured to drive the stage within the moving stroke of the stage;
and
a brake unit which includes an eddy current generating member arranged so as to suppress movement of the first magnet.

12. An exposure apparatus comprising:
an optical system configured to project exposure light, which strikes an original plate on which a pattern is formed, onto a substrate; and
a stage apparatus defined in claim 1, which is configured to hold and align one of the substrate and the original plate.

13. A device manufacturing method comprising the steps of:
preparing a substrate on which a latent image pattern is formed using an exposure apparatus defined in claim 12; and
developing the latent image pattern.
